(19) United States
(12) Patent Application Publication
(10) Pub. No.: US 2025/0078276 A1
(43) Pub. Date: Mar. 6, 2025

(54) SYSTEMS AND METHODS FOR LEARNING ANATOMICALLY CONSISTENT EMBEDDING FOR CHEST RADIOGRAPHY

(71) Applicants: Ziyu Zhou, Shanghai (CN); Haozhe Luo, Zurich (CH); Jiaxuan Pang, Tempe, AZ (US); Jianming Liang, Scottsdale, AZ (US)

(72) Inventors: Ziyu Zhou, Shanghai (CN); Haozhe Luo, Zurich (CH); Jiaxuan Pang, Tempe, AZ (US); Jianming Liang, Scottsdale, AZ (US)

(73) Assignee: Arizona Board of Regents on Behalf of Arizona State University, Tempe, AZ (US)

(21) Appl. No.: 18/825,923

(22) Filed: Sep. 5, 2024

Related U.S. Application Data
(60) Provisional application No. 63/580,946, filed on Sep. 6, 2023.

(51) Int. Cl. G06T 7/00

(52) U.S. Cl. CPC G06T 7/0014; G06T 2207/10116; G06T 2207/20004; G06T 2207/20081; G06T 2207/20132

(57) ABSTRACT

A model implemented by a processor and trained for patch embedding of anatomical consistency captures the anatomical structure consistency between patients of different genders and weights and between different views of the same patient, which enhances the interpretability for medical image analysis. The model is trained via a self-supervised learning (SSL) framework that captures both global and local patterns embedded within medical images.

### CROSS REFERENCE TO RELATED APPLICATIONS

This is a non-provisional application that claims benefit to U.S. Provisional Application Ser. No. 63/580,946, filed on Sep. 6, 2023, which is herein incorporated by reference in its entirety.

### GOVERNMENT SUPPORT

This invention was made with government support under R01 HL128785 awarded by the National Institutes of Health. The government has certain rights in the invention.

### FIELD

The present disclosure generally relates to artificial intelligence (AI) applications in medical imaging; and more particularly to a self-supervised learning approach for patch embedding of anatomical consistency applicable to, e.g., medical image analysis.

### BACKGROUND

Labeling medical images is tedious, laborious, and timeconsuming and demands specialty-oriented expertise. Most Al-driven image analysis methods have been developed for photographic images, and directly adopting these to medical images may not achieve optimal results because medical images are markedly different from photographic images. Photographic images, like those in ImageNet, are object-centric, where dominant objects (e.g., dogs and cats) are located at the center with backgrounds of large variation. Naturally, these Al methods developed for photographic images mostly learn from foreground objects. By contrast, medical images acquired with the same imaging protocol have similar anatomical structures, and imaging diagnosis requires not only analyzing “foreground” objects: diseases (abnormalities) but also understanding “background” anatomical structures; furthermore, diseases are often small and obscured in “background” anatomical structures.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a series of X-ray images showing anatomical patterns that can be analyzed using the functionality described herein.

FIG. 1B is another series of X-ray images showing anatomical patterns that can be analyzed using the functionality described herein.

FIG. 2 is series of images illustrating grid-wise cropping for stable grid-based matching.

FIG. 3 is a series of illustrations demonstrating an architecture of Patch Embedding of Anatomical Consistency (PEAC) as described herein.

FIG. 4 is a pair of graphs showing grid-based matching shows better performance than block matching.

FIG. 5 is a series of images showing effectiveness of the PEACH model described herein to localize arbitrary anatomical structures across views of the same patient and across different demographics and associated parameters.

FIG. 6 is a series of illustrations demonstrating valid embedding space with the PEAC model described herein.

FIG. 7 is a series of images showing co-segment common structure of images in a zero-shot scenario.

FIG. 8 is a series of images showing comparison of the PEAC model with other models in matching anatomical structures across distinct patients.

FIG. 9 is a series of images establishing anatomical correspondence across views, across subject weights, across genders, and across health statuses.

FIG. 10 is an example computer-implemented system for implementing the SSL (PEAC) model described herein.

FIG. 11 is an example (computer-implemented) method for implementing the SSL (PEAC) model described herein.

Corresponding reference characters indicate corresponding elements among the view of the drawings. The headings used in the figures do not limit the scope of the claims.

### DETAILED DESCRIPTION

The present disclosure relates to a self-supervised learning (SSL) model implemented by at least one processor and trained for consistent embedding of anatomical consistency (for, e.g., chest radiography).

More specifically, SSL approaches have recently shown substantial success in learning visual representations from unannotated images. Compared with photographic images, medical images acquired with the same imaging protocol exhibit high consistency in anatomy. To exploit this anatomical consistency, the novel SSL model approach is described herein, dubbed PEAC (patch embedding of anatomical consistency), for medical image analysis. In example implementations of the model, it is proposed to learn global and local consistencies via stable grid-based matching, transfer pre-trained PEAC models to diverse downstream tasks, and extensively demonstrate that (1) PEAC achieves significantly better performance than the existing state-of-the-art fully-supervised and self-supervised methods, and (2) PEAC effectively captures the anatomical structure consistency between patients of different genders and weights and between different views of the same patient, which enhances the interpretability of the proposed methods for medical image analysis.

In some embodiments the present disclosure describes a system for medical image analysis comprising:
a processor configured to execute one or more operations; and
a memory in operable communication with the processor storing instructions the processor executes to execute the one or more operations, to:
   access a plurality of medical images; and
   match one or more anatomical structures across the plurality of medical images by input of the plurality of medical images to a model trained for patch-matching that captures both global and local patterns embedded within medical images.

In some embodiments, the model associated with a self-supervised learning (SSL) framework that defines a Student-Teacher model may extract features of two crops simultaneously.

In some embodiments, the SSL framework includes an image augmentation and restoration module that aims to restore image crops from the two augmentation ways shuffle patches and add noise.

In some embodiments, the SSL framework includes a global module that aims to enforce the model to learn coarse-grained global features of two crops.

In some embodiments, the SSL framework includes a local module that aims to enforce the model to learn fine-grained local features from overlapped patches.

In some embodiments, under the SSL framework the model learns coarse-grained, fine-grained and contextualized high-level anatomical structure features.

In some embodiments, prior to input to the model, the plurality of medical images is pre-processed in grid-wise cropping to get two crops x, x′∈R^{C×H×W}, C is the number of channels, (H, W) are the crops' spatial dimensions.

In some embodiments, the two crops are input to Student and Teacher encoders f_{θ}_{ₛ}, f_{θ}_{ₜ} to get the local features s, t respectively.

In some embodiments, average pooling operators ⊕: R^{D×H×W}→R^{D} are performed on the local features and the pooled representations are denoted as y_{s⊕} and y_{t⊕}∈R^{D}.

In some embodiments, the processor applying the model in view of the plurality of medical images matches the anatomical structures across different patients.

In some embodiments, the processor applying the model in view of the plurality of medical images matches the anatomical structures across different views of the same patient.

In some embodiments, the model calculates the consistency loss based on the absolute positions of overlapping image patches of the plurality of medical images.

In some embodiments, the model as trained:
takes, utilizing a student-teacher architecture, a first crop and a second crop from overlapped patches of an image; and
learns high-level relationships among anatomical structures by patch order classification and fine-grained image features by patch appearance restoration.

In some embodiments, the model integrates the first crop with the second crop to learn consistent contextualized embedding for coarse-grained global anatomical structures.

In some embodiments, analogous regions of the plurality of medical images are captured by the first and second crops so that global embedding consistency encourages extraction of features of similar local regions.

In some embodiments, the model learns fine-grained and precise anatomical structures from local patch embeddings of overlapped parts.

In some embodiments, the model defines a network that that considers both global and local features of medical images at the same time.

In some embodiments, the model localizes arbitrary anatomical structures across views of the same patient and across patients of different genders and weights and of health and disease.

In some embodiments, the present disclosure describes a method comprising:
accessing a plurality of medical images; and
matching, by a processor, one or more anatomical structures across the plurality of medical images by input of the plurality of medical images to a model trained for patch-matching that captures both global and local patterns embedded within medical images.

In some embodiments, the present disclosure describes a nontransitory, computer-readable medium storing instructions encoded thereon, the instructions, when executed by one or more processors, cause the one or more processors to perform operations to:
access a plurality of medical images; and
match one or more anatomical structures across the plurality of medical images by input of the plurality of medical images to a model trained for patch-matching that captures both global and local patterns embedded within medical images.

### 1. Introduction

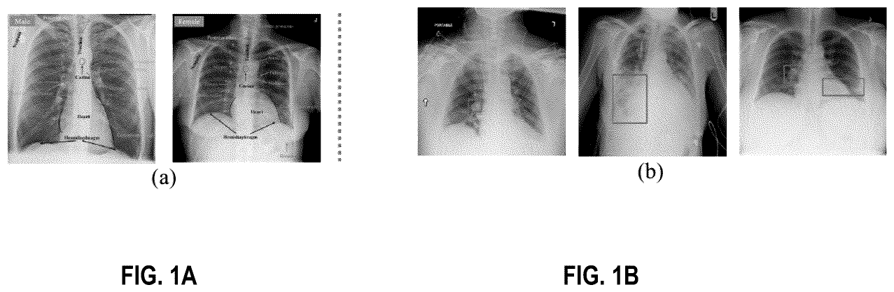

Self-supervised learning (SSL) pretrains generic source models without using expert annotation, allowing the pretrained generic source models to be quickly fine-tuned into high-performance application-specific target models and minimizing annotation cost. This paradigm is particularly attractive in medical imaging because labeling medical images is tedious, laborious, and time-consuming and demands specialty-oriented expertise. However, most existing SSL methods were developed for photographic images, and directly adopting these SSL methods to medical images may not achieve optimal results because medical images are markedly different from photographic images. Photographic images, like those in ImageNet, are object-centric, where dominant objects (e.g., dogs and cats) are located at the center with backgrounds of large variation. Naturally, these SSL methods developed for photographic images mostly learn from foreground objects. By contrast, medical images acquired with the same imaging protocol have similar anatomical structures, and imaging diagnosis requires not only analyzing “foreground” objects: diseases (abnormalities) but also understanding “background” anatomical structures; furthermore, diseases are often small and obscured in “background” anatomical structures. In the present disclosure, exemplary embodiments are illustrated with chest X-rays because the chest contains several critical organs prone to a number of diseases associated with significant healthcare costs, and chest X-rays are one of the most frequently used modalities in imaging the chest. Referring to FIGS. 1A, chest X-rays contain various large (global) and small (local) anatomical patterns, including the right/left lung, heart, spinous process, clavicle, mainstem bronchus, hemidiaphragm, and the osseous structures of the thorax, that can be utilized for learning consistent embedding in anatomy. Referring to FIG. 1B, diagnosing chest diseases at chest X-rays involves identifying focal and diffuse patterns, such as Mass, Infiltrate, and Atelectasis as boxed, that can be exploited for learning consistent embedding in disease.

As illustrated in FIGS. 1A-1B, with chest X-rays there are large and small anatomical structures, such as the right/left lung, heart, and spinous processes; lung diseases can be local or global. The subject inventive disclosure seeks to answer this critical question: How to autodidactically learn generic source models from global and local patterns in health and disease?

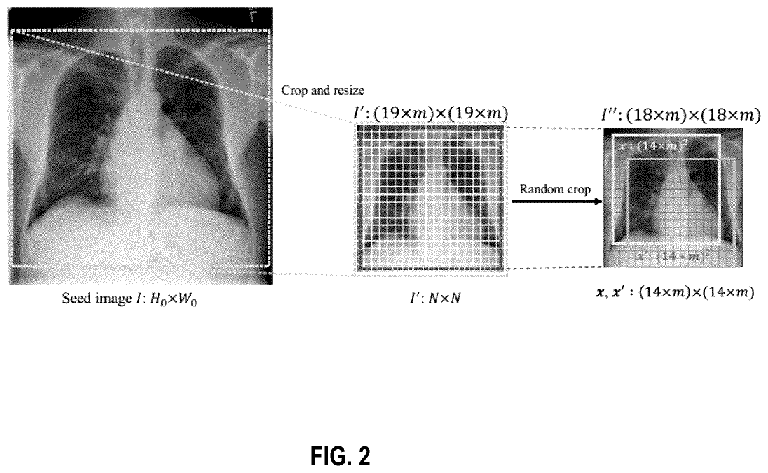

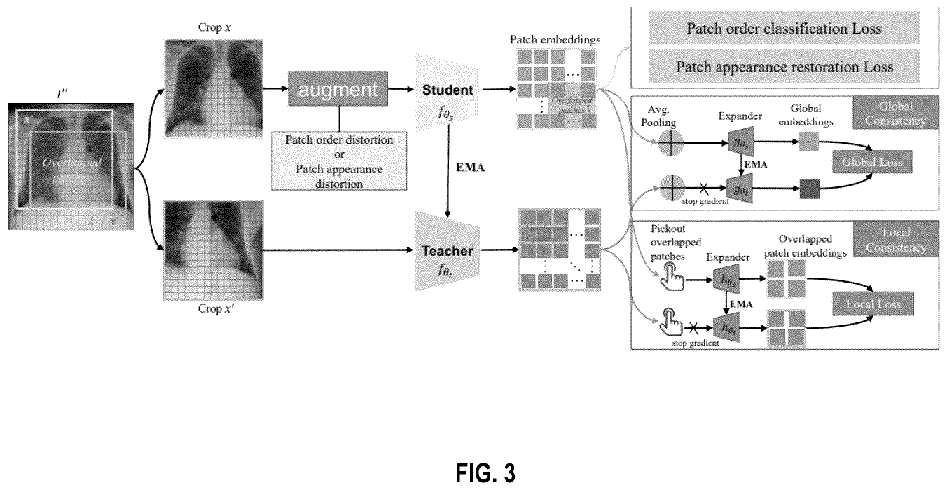

To answer this question, a novel SSL framework is presented, called PEAC (patch embedding of anatomical consistency), configured to exploit global and local patterns in health and disease. FIG. 2 shows an illustration and images associated with grid-wise cropping for stable grid-based matching. Firstly, a seed image I is cropped from an original chest X-ray and resized to Image I′ of size (n×m), so that I′ can be conveniently partitioned to n×n patches with each patch size of size m×m. By default, n=19 and m=32 in PEAC. Secondly, Image I′ with size ((n−1)×m)×((n−1)×m)) is randomly cropped from I′ to ensure a large diversity of local patches during training. Thirdly, Crops x and x′ of size (k×m)×(k×m) are randomly extracted from Image I′ in alignment with the grid of Image I′ to ensure the exact correspondence of local matches in the overlapped region between Crops x and x′ (referred to stable grid-based matching and detailed in Section 4.3 herein). By default, k=14 in PEAC. Referring to FIG. 3, examples of PEAC include an architecture of student-teacher, taking two global crops: x for the student and x′ for the teacher, with overlaps from a chest X-ray to learn the global consistency (Eq. 1) between the two global crops (x and x′) and the local consistency (Eq. 2) between each pair of corresponding local patches within the overlapped region of the two global crops (x and x′). The student, built on a system called POPAR, learns high-level relationships among anatomical structures by patch order classifications and fine-grained image features by patch appearance restoration. Integrating the teacher with the student aims to learn consistent contextualized embedding for coarse-grained global anatomical structures and fine-grained local anatomical structures across different views of the same patients, leading to anatomically consistent embedding across patients.

As illustrated in FIGS. 2-3, PEAC can include an architecture of student-teacher, taking two global crops, one for the student and the other for the teacher, with overlaps from a chest X-ray to learn the global consistency between the two global crops and the local consistency between each pair of corresponding local patches within the overlapped region of the two global crops. Extensive experiments have demonstrated that PEAC outperforms fully-supervised pretrained models on ImageNet or ChestX-ray14 and SoTA SSL methods, and offers consistent representation of similar anatomical structures across diverse patients of different genders and weights and across different views of the same patient.

Several features of the PEAC framework and example model implementations include, but are not limited to:
A straightforward yet effective SSL scheme that captures both global and local patterns embedded within medical images;
A precise and stable patch-matching method that achieves anatomical embedding consistency in health and disease;
Extensive illustrations that show the capability of PEAC in matching anatomical structures across different patients and across different views of the same patient and in segmenting anatomical structures by zero-shot;
Thorough experiments that demonstrate the transferability of PEAC to various target tasks, outperforming SoTA full-supervised and self-supervised methods in classification and segmentation.

### 2. Global Features and Local Features

Global features describe the overall appearance of the image. Most recent methods for global feature learning are put forward to ensure that the extracted global features are consistent across different view. The methods to achieve this include contrastive learning and non-contrastive learning methods. Contrastive methods bring representation of different views of the same image closer and spreading representations of views from different images apart. Non-contrastive methods rely on maintaining the informational content consistent of the representations by either explicit regularization or architecture design like Siamese architecture. In opposition to global methods, local features describe the information that is specific to smaller regions of the image. In local features learning methods, a contrastive or consistent loss can be applied directly at pixel level, feature map level or image region level which forces consistency between pixels at similar locations, between groups of pixels and between large regions that overlap in different view of an image. However, at present, the vast majority of methods that use local features calculate embedding consistency or contrastive learning loss based on the relative positions of the features, such as the feature vectors of semantically closest patches or spatially nearest neighbor patches. In contrast, the PEAC method described herein calculates the consistency loss based on the absolute positions of overlapping image patches shown in FIG. 2. In this way, fine-grained anatomical structures can be more accurately characterized.

### 3. Example Methods

As depicted in the Examples below, in certain exemplary embodiments, methods of the present disclosure are illustrated with chest X-rays because the chest contains several critical organs prone to a number of diseases associated with significant healthcare costs, and chest X-rays are one of the most frequently used modalities in imaging the chest. It will be appreciated that, although the general methods depict analysis of chest X-rays, the following general methods, can be applied to other medical images.

One goal of a method associated with Patch Embedding of Anatomical Consistency (PEAC) is to learn global and local anatomical structures underneath medical images. In medical images, there will be a large scale of local patterns such as spinous processes, clavicle, mainstem bronchus, hemidiaphragm, the osseous structures of the thorax, etc. The analogous regions can be captured by the two global crops shown in FIG. 3 so that global embedding consistency can encourage the network to extract high-level semantic features of similar local regions. Besides, as for the diseases diagnosing needs single or multiple local patterns, local embedding consistency-based grid-like image patches can equip the model to be more stable and learn fine-grained anatomical structure. Therefore, a network is proposed that considers both global and local features of medical images at the same time.

As shown in FIG. 3, PEAC is an SSL framework comprised of four key components: (1) Student-Teacher model that aims to extract features of two crops simultaneously; (2) image augmentation and restoration module that aims to restore image crops from the two augmentation ways shuffle patches and add noise; (3) global module that aims to enforce the model to learn coarse-grained global features of two crops; (4) local module that aims to enforce the model to learn fine-grained local features from overlapped patches. By integrating the above modules, the model learns the coarse-grained, fine-grained and contextualized high-level anatomical structure features. In the following, example methods from image preprocessing are introduced, each components and the joint training loss. The subject model is based on POPAR because it is needed to model the overall structural information and local detailed and robust information of medical images.

### 3.1 Global Embedding Consistency

Before inputting to the model, seed images are pre-processed in grid-wise cropping to get two crops x,x′∈R^{C×H×W}, C is the number of channels, (H, W) are the crops' spatial dimensions, shown in FIG. 2. Then the two crops are input to the Student and Teacher encoders f_{θ}_{ₛ}, f_{θ}_{ₜ} to get the local features s, t respectively. Then in the global branch the average pooling operators ⊕:R^{D×H×W}→R^{D} are performed on the local features. The pooled representations are denoted as y_{s⊕} and y_{t⊕}∈R^{D}. At last the expanders g_{θ}_{ₛ}, g_{θ}_{ₜ} are 3-layer mlp which map y_{s⊕}, y_{t⊕} to get the embedding vectors yₛ, yₜ∈R^{H}. The l₂-normalize is put to y̅ₛ=yₛ/∥yₛ∥₂ and y̅ₜ=yₜ/∥yₜ∥₂. At last, global patch embedding consistency loss is defined as the following mean square error between the normalized output,

$${ℒ}_{{θ}_{s} , {θ}_{t}}^{global} {=}^{△} {‖ \overline{{y}_{s}} - \overline{{y}_{t}} ‖}_{2}^{2} = 2 - 2 \cdot \frac{{y}_{s} - {y}_{t}}{{‖ {y}_{s} ‖}_{2} \cdot {‖ {y}_{t} ‖}_{2}} \qquad ( 1 )$$

The loss from Eq. 1 is symmetrized by separately feeding x to Teacher encoder and x′ to Student encoder to compute [symbol] _{θ}_{ₛ}_{,θ}_{ₜ}^{global}. Accordingly, the global loss is provided as [symbol] _{θ}_{ₛ}_{,θ}_{ₜ}^{G}= [symbol] _{θ}_{ₛ}_{,θ}_{ₜ}^{global}+ [symbol] _{θ}_{ₛ}_{,θ}_{ₜ}^{global}.

### 3.2 Local Embedding Consistency

As the encoders are associated with a Vision Transformer network, the crop is divided into a sequence of N non-overlapping image patches P=(p₁, p₂, . . . , P_{N}) where

$$N = \frac{H \times W}{{m}^{2}}$$

and m is the patch resolution. The encoder of the Student-Teacher model extracts local features s, t∈R^{D×N} from the two crops x, x′. One can denote sₖ and tₖ∈R^{D} the feature vectors at position k∈[1, . . . , N] in their corresponding feature maps. Since the image patches are randomly sampled from an image grid with an overlap rate of 50%-100%, the overlapping image patches Oₘ, Oₙ are defined for x and x′ respectively, and m∈[m₁, . . . , m_{z}], n∈[n₁, . . . , n_{z}] are the patch indexes of the overlapping region, z is the number of overlapping patches. Oₘ_{ᵢ} and Oₙ_{₁} are in correspondence where 1≤i≤z and this process is called grid matching. Correspondingly, Oₘ and Oₙ are transformed into embedding vectors oₘ and oₙ through the feature extractors. Then in the local module there are 3-layer mlp expanders h_{θ}_{ₛ}, h_{θ}_{ₜ} adding to oₘ, oₙ to get the final local patch embedding vectors pₘ, pₙ. Similarly, one can put l₂-normalize to p̅ₘ̅=pₘ/∥pₘ∥₂, p̅ₙ̅=pₙ/∥pₙ∥₂. Patch order distortion and patch appearance distortion can be randomly added in the student branch. When the patch order is distorted, the patch embedding vector will represent the distorted global feature for attention mechanism. And local embeddings of distorted and non-distorted patch orders in the student and teacher branches can't be consistent. So local loss won't be computed if the crop gains patch order distortion (indicator [symbol] =0) while it has no impact on the patch appearance distortion ( [symbol] =1). To align the output of the student and teacher networks regarding local features, the following local patch embedding consistency loss function is defined in Eq. 2.

$${ℒ}_{{θ}_{s} , {θ}_{t}}^{local} {=}^{△} \frac{1}{B} {\sum }_{b = 1}^{B} 𝕀 \cdot {\sum }_{i = 1}^{z} {‖ \overline{{p}_{{m}_{i}}} - \overline{{p}_{{m}_{i}}} ‖}_{2}^{2} \qquad ( 2 )$$

As indicated, pₘ_{ᵢ} and pₙ_{ᵢ} are the embedding vectors of the i-th overlapping image patches and B is the batch size. Similar to the global loss in previous section, when x is fed into Teacher encoder and x′ is fed into Student encoder, the corresponding loss [symbol] _{θ}_{ₛ}_{,θ}_{ₜ}^{local} is computed. So the local loss [symbol] _{θ}_{ₛ}_{,θ}_{ₜ}^{L}= [symbol] _{θ}_{ₛ}_{,θ}_{ₜ}^{local}+ [symbol] _{θ}_{ₛ}_{,θ}_{ₜ}^{local}.

$${ℒ}_{{θ}_{s}}^{oc} = \frac{1}{B} {\sum }_{b = 1}^{B} {\sum }_{l = 1}^{n} {\sum }_{c = 1}^{n} y log {𝒫}^{o}$$

can be calculated and

$${ℒ}_{{θ}_{s}}^{ar} = \frac{1}{B} {\sum }_{i = 1}^{B} {\sum }_{j = 1}^{n} {‖ {p}_{j} - {p}_{j}^{a} ‖}_{2}^{2}$$

can be calculated for patch order distortion and patch appearance distortion in the student branch. Where n is the number of patches for each image, [symbol] represent the order ground truth and [symbol] ^{O} represent the network's patch order prediction, pⱼ and pⱼ^{a} represent image original appearance and reconstruction prediction.

Finally, the total loss is defined in Eq. 3, where [symbol] _{θ}_{ₛ}^{oc} is patch order classification loss, [symbol] _{θ}_{ₛ}^{ar} is patch appearance restoration loss, [symbol] _{θ}_{ₛ}_{,θ}_{ₜ}^{G} is the global patch embedding consistency loss and [symbol] _{θ}_{ₛ}_{,θ}_{ₜ}^{L} is the local patch embedding consistency loss. [symbol] _{θ}_{ₛ}^{oc} and [symbol] _{θ}_{ₛ}^{ar} empower the model to learn high-level anatomical structures. The [symbol] _{θ}_{ₛ}_{,θ}_{ₜ}^{G} equips the model to learn the coarse-grained granularity and synthetical anatomy from global patch embeddings. [symbol] _{θ}_{ₛ}_{,θ}_{ₜ}^{L} lets the model learn fine-grained and precise anatomical structures from local patch embeddings of overlapped parts.

$$ℒ = {ℒ}_{{θ}_{s}}^{oc} + {ℒ}_{{θ}_{s}}^{ar} + {ℒ}_{{θ}_{s} , {θ}_{t}}^{G} + {ℒ}_{{θ}_{s} , {θ}_{t}}^{L} \qquad ( 3 )$$

### 4. Experiments

### 4.1 Datasets and Implementation Details

Pretraining Settings. PEAC can be pretrained with Swin-B as the backbone on an unlabeled ChestX-ray14 dataset. The PEAC and PEAC⁻¹ models can utilize Swin-B as the backbone, pre-trained on an image size of 448 and fine-tuned on 448 and 224 respectively. PEAC⁻³ adopts ViT-B as the backbone, pretrained and fine-tuned on an image size of 224. As for the prediction heads in the student branch, two single linear layers can be used for the classification (patch order) and restoration tasks (patch appearance), and two 3-layer mlp for the expanders of local and global features. The augments used in the student branch include 50% probability of patch appearance distortion and 50% probability of shuffling patches. More details are described below.

Target Tasks and Datasets. The effectiveness of the inventive method is validated by evaluating it on four downstream datasets including ChestX-ray14, CheXpert, NIH Shenzhen CXR, and RSNA Pneumonia. These are 2D X-ray medical-image datasets for multi-label classification. When fine-tuning on downstream tasks, the final prediction layer is removed and only the parameters of the encoder are used. Randomly initialized linear classification heads are also added for each downstream dataset and finetune the whole parameters for 150 epochs. Details for datasets and target tasks are provided below.

TABLE 1
PEAC models outperform fully supervised pretrained models on ImageNet and ChestX-ray14 datasets in four
target tasks across architectures. The best methods are bolded while the second best are underlined.
Transfer learning is inapplicable, when pretraining and target tasks are the same, and denoted by “—”.

| Backbone | Pretraining data | Pretraining method | ChestX-ray14 | CheXpert | ShenZhen | RSNA Pneumonia |
|---|---|---|---|---|---|---|
| ResNet-50 | No pretraining (i.e., training from scratch) | | 80.40 ± 0.05 | 86.60 ± 0.17 | 90.49 ± 1.16 | 70.00 ± 0.50 |
| | ImageNet-1K | Fully-supervised | 81.70 ± 0.15 | 87.17 ± 0.22 | 94.96 ± 1.19 | 73.04 ± 0.35 |
| | ChestX-ray14 | Fully-supervised | — | 87.40 ± 0.26 | 96.32 ± 0.65 | 71.64 ± 0.37 |
| ViT-B | No pretraining (i.e., training from scratch) | | 70.84 ± 0.19 | 80.78 ± 0.13 | 84.46 ± 1.65 | 66.59 ± 0.39 |
| | ImageNet-21K | Fully-supervised | 77.55 ± 1.82 | 83.32 ± 0.69 | 91.85 ± 3.40 | 71.50 ± 0.52 |
| | ChestX-ray14 | Fully-supervised | — | 84.37 ± 0.42 | 91.23 ± 0.81 | 66.96 ± 0.24 |
| | ChestX-ray14 | PEAC−³ (self-supervised) | 80.04 ± 0.20 | 88.10 ± 0.29 | 96.69 ± 0.30 | 73.77 ± 0.39 |
| Swin-B | No pretraining (i.e., training from scratch) | | 74.29 ± 0.41 | 85.78 ± 0.01 | 85.83 ± 3.68 | 70.02 ± 0.42 |
| | ImageNet-21K | Fully-supervised | 81.32 ± 0.19 | 87.94 ± 0.36 | 94.23 ± 0.81 | 73.15 ± 0.61 |
| | ChestX-ray14 | Fully-supervised | — | 87.22 ± 0.22 | 91.35 ± 0.93 | 70.67 ± 0.18 |
| | ChestX-ray14 | PEAC−¹(self-supervised) | 81.90 ± 0.15 | 88.64 ± 0.19 | 97.17 ± 0.42 | 73.70 ± 0.48 |
| | ChestX-ray14 | PEAC (self-supervised) | 82.78 ± 0.21 | 88.81 ± 0.57 | 97.39 ± 0.19 | 74.39 ± 0.66 |

### 4.2 Experimental Results:

(1) PEAC outperforms fully-supervised pretrained models. The performance of PEAC on four downstream tasks is compared with different initialization methods. As shown in Table 1, PEAC model outperforms both supervised ImageNet and ChestX-ray14 models, demonstrating that PEAC has learned transferable features for various medical image tasks.
(2) PEAC outperforms self-supervised models pretrained on ImageNet. PEAC models pretrained on ChestX-rays14 are compared with the transformer-based models pretrained on ImageNet by various SOTA self-supervised methods including MoCo V3, SimMIM, DINO, BEIT, and MAE. The results in Table 2 show that the PEAC pretrained on moderately-sized unlabeled chestX-rays14 yields better results than the aforementioned SSL methods pretrained on larger ImageNet, revealing the transferability of PEAC via learning anatomical consistency with indomain medical data.
(3) PEAC outperforms recent self-supervised models pretrained on medical images. To demonstrate the effectiveness of representation learning via the proposed framework, PEAC is compared with SoTA CNN-based (SimSiam, MoCo V2, Barlow Twins) and transformer-based SSL methods (SimMIM) pretrained on medical images as shown in Table 3. The inventive method described herein yields the best performance across four datasets and verifies its effectiveness on different backbones. Several observations are made from the results: (1) In transformer backbones, the methods described herein outperform SimMIM which demonstrates that patch order distortion and patch embedding consistency are effective; (2) In Swin-B backbone, the subject method outperforms POPAR⁻¹ which shows the good generalization performance of patch embedding consistency.

TABLE 2
Even downgraded PEAC⁻¹ and PEAC⁻³ outperform SoTA self-supervised Ima-geNet
in four target tasks. The best results are bolded and the second best are underlined.

| | Pretrained | | | | | RSNA |
|---|---|---|---|---|---|---|
| Backbone | dataset | Method | ChestX-ray14 | CheXpert | ShenZhen | Pneumonia |
| ViT-B | ImageNet | MoCo V3 | 79.20 ± 0.29 | 86.91 ± 0.77 | 85.71 ± 1.41 | 72.79 ± 0.52 |
| | | SimMIM | 79.55 ± 0.56 | 87.83 ± 0.46 | 92.74 ± 0.92 | 72.08 ± 0.47 |
| | | DINO | 78.37 ± 0.47 | 86.91 ± 0.44 | 87.83 ± 7.20 | 71.27 ± 0.45 |
| | | BEiT | 74.69 ± 0.29 | 85.81 ± 1.00 | 92.95 ± 1.25 | 72.78 ± 0.37 |
| | | MAE | 78.97 ± 0.65 | 87.12 ± 0.54 | 93.58 ± 1.18 | 72.85 ± 0.50 |
| | ChestX-ray14 | PEAC⁻³ | 80.04 ± 0.20 | 88.10 ± 0.29 | 96.69 ± 0.30 | 73.77 ± 0.39 |
| Swin-B | ImageNet | SimMIM | 81.39 ± 0.18 | 87.50 ± 0.23 | 87.86 ± 4.92 | 73.15 ± 0.73 |
| | ChestX-ray14 | PEAC⁻¹ | 81.90 ± 0.15 | 88.64 ± 0.19 | 97.17 ± 0.42 | 73.70 ± 0.48 |
| | | PEAC | 82.78 ± 0.21 | 88.81 ± 0.57 | 97.39 ± 0.19 | 74.39 ± 0.66 |

### 4.3 Ablations:

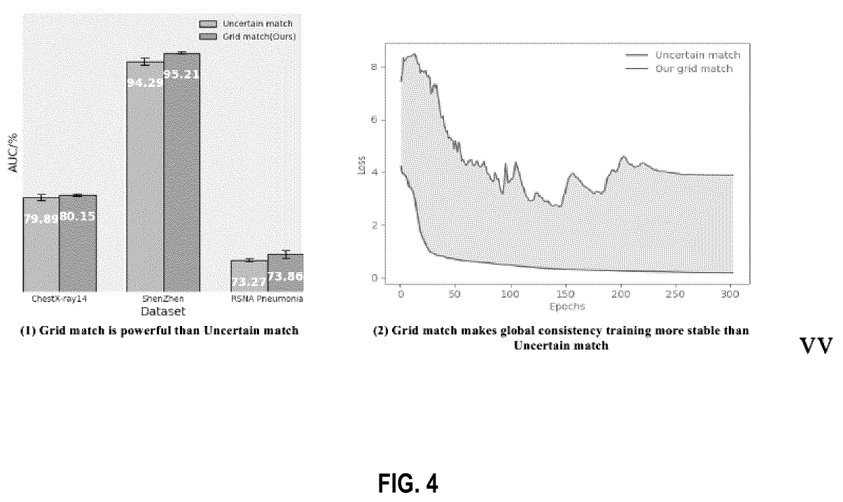

(1) Transformer grid-based matching is more stable. Calculating local consistency requires the correspondence between patches across views. Existing block matching [4, 31] is derived based on the adjacent position or cosine similarity of embedding vectors between blocks, leading to inexact matches, resulting in training instability and unreliability. By contrast, the grid-based matching described herein (illustrated in FIG. 2) is more stable as shown in FIG. 4.
(2) Local consistency improves performance. The local loss is removed and several different backbones can be used to demonstrate the effectiveness of local embedding consistency. The discussions and table of the results can be found in the supplementary materials.
(3) Student-teacher model (global consistency) boosts all one branch methods. In the subject experiments it was found that the student-teacher model can be applied to one-branch self-supervised methods and boosts their performance. The results are included in the supplementary materials.

### 4.4 Visualization of Upstream Models:

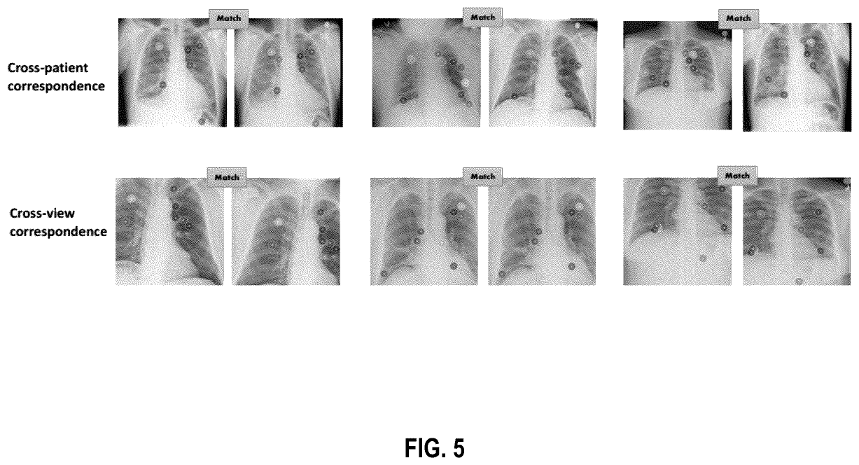

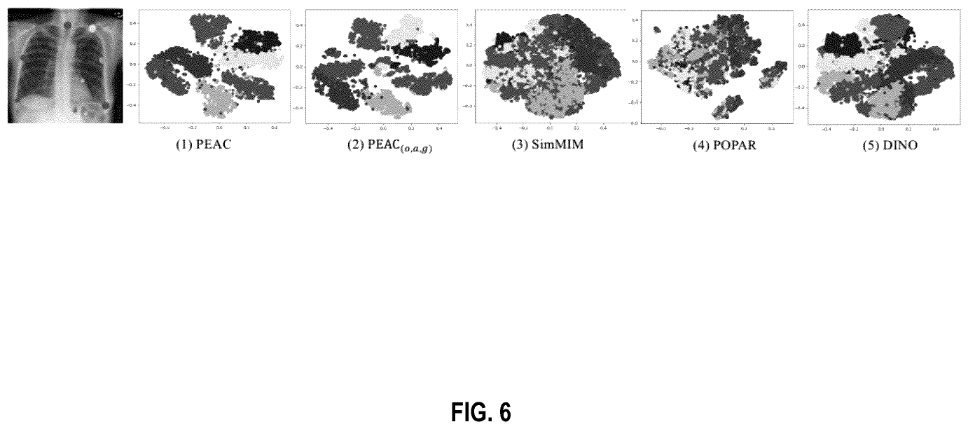

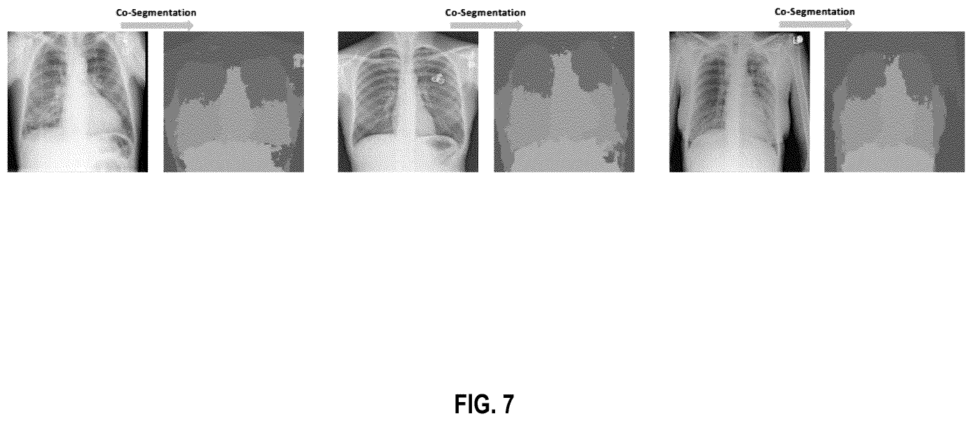

(1) Cross-patient and cross-view correspondence. The information contained in the subject patch-level features was investigated by matching them across patients and different views of the same image, as shown in FIG. 5. Observations suggest that these features capture semantic regions and exhibit robustness across samples with large morphological differences and both sexes. Similar semantic regions are also stably captured in different views of the same sample. Results were compared to models trained with other methods, which exhibited obvious incorrect matches. Further details are available in the supplementary materials.
(2) t-SNE of landmark anatomies across patients. One can use t-sne on 7 labeled local landmark anatomies across 1000 patient images. Each local anatomy is labeled with different color which corresponds with the t-sne cluster color in FIG. 6. This shows the PEAC's ability to learn a valid embedding space among different local anatomical structures.
(3) Zero shot co-segmentation. Without finetuning on downstream tasks, one can jointly segment analogous structures common to all images in a given set as shown in FIG. 7. In the segmentation results, different anatomical structures clearly segmented as common features suggests that the proposed model demonstrates proficiency in extracting and representing the distinguishing features of various anatomical regions.

TABLE 3
To speed up the training process, the performance of downstream tasks was compared using
image resolution of 224. All models are pretrained on the ChestX-ray14 dataset.

| | Pretrained | | | | | RSNA |
|---|---|---|---|---|---|---|
| Backbone | dataset | Method | ChestX-ray14 | CheXpert | ShenZhen | Pneumonia |
| RestNet-50 | ChestX-ray14 | SimSiam | 79.62 ± 0.34 | 83.82 ± 0.94 | 93.13 ± 1.36 | 71.20 ± 0.60 |
| | | MoCoV2 | 80.36 ± 0.26 | 86.42 ± 0.42 | 92.59 ± 1.79 | 71.98 ± 0.82 |
| | | Barlow Twins | 80.45 ± 0.29 | 86.90 ± 0.62 | 92.17 ± 1.54 | 71.45 ± 0.82 |
| ViT-B | ChestX-ray14 | SimMIM | 79.20 ± 0.19 | 83.48 ± 2.43 | 93.77 ± 1.01 | 71.66 ± 0.75 |
| | | PEAC−³ | 80.04 ± 0.20 | 88.10 ± 0.29 | 96.69 ± 0.30 | 73.77 ± 0.39 |
| Swin-B | ChestX-ray14 | SimMIM | 79.09 ± 0.57 | 86.75 ± 0.96 | 93.03 ± 0.48 | 71.99 ± 0.55 |
| | | POPAR−¹ | 80.51 ± 0.15 | 88.16 ± 0.66 | 96.81 ± 0.40 | 73.58 ± 0.18 |
| | | PEAC−¹ | 81.90 ± 0.15 | 88.64 ± 0.19 | 97.17 ± 0.42 | 73.70 ± 0.48 |

### 4.5 Pretrained Settings

The PEAC was implemented on ViT-B and Swin-B for their notable scalability, global receptibility, and interpretability. Both PEACs are trained on ChestX-ray14 by amalgamating the official training and validation splits. In PEAC ViT-B, input images of size 224×224 lead to 196 (14×14) shufflable patches, while in PEAC Swin-B, it results in 49 (7×7) shufflable patches due to the Swin hierarchical architecture. To learn the same contextual relationship as in PEAC ViT-B, PEAC Swin-B was pretrained with images of size 448×448, but the tissue (physical) size covered by the images remains unchanged, resulting in the same 196 (14×14) shufflable patches in terms of the (physical) tissue size.

In PEAC, a multi-class linear layer is designated for patch order classification (Eq. 1), and a single convolutional block is employed for patch appearance restoration (Eq. 2). The global and local consistency branches utilize two 3-layer MLPs as expanders before computing consistency losses. When training PEAC, one can use a learning rate of 0.1, a momentum of 0.9 for the SGD optimizer, a warmup period of 5 epochs, and a batch size of 8. The teacher model is updated after each iteration via EMA with an updating parameter of 0.999. For Nvidia RTX3090 GPUs were used for training PEAC models with images of size 224×224 for 300 epochs, but the number of epoch was reduced to 150 when the image size is 448×448.

### 4.6 Target Tasks and Datasets

The PEAC models were evaluated by finetuning on four classification target tasks:
ChestX-ray14, which contains 112K frontal-view X-ray images of 30805 unique patients with the text-mined fourteen disease image labels (where each image can have multi-labels). The official training set 86K was used (90% for training and 10% for validation) and testing set at 25K.
CheXpert, which includes 224K chest radiographs of 65240 patients and capturing 14 thoracic diseases. The official training data split 224K was used for training and validation set 234 images for testing. Training was conducted on the 14 thoracic diseases but follow the standard practice by testing on 5 diseases (Atelectasis, Cardiomegaly, Consolidation, Edema, and Pleural Effusion).
NIH Shenzhen CXR, which contains 326 normal and 336 Tuberculosis (TB) frontal-view chest X-ray images. 70% of the dataset was split for training, including 10% for validation and 20% for testing;
RSNA Pneumonia, which consists of 26.7K frontal view chest X-ray images and each image is labeled with a distinct diagnosis, such as Normal, Lung Opacity and Not Normal (other diseases). 80% of the images are used to train, 10% to valid and 10% to test. These target datasets are composed of both multi-label and multi-class classification tasks with various diseases.

### 4.7 Finetuning Setting

The PEAC pretrained models were transferred to each target task by fine-tuning the whole parameters for the target classification tasks. For the target classification tasks, a randomly initialized linear layer was concatenated to the output of the classification (CLS) token of PEAC ViT-B models. Due to the structural difference with ViT-B model, PEAC Swin-B models don't equip the CLS token and an average pooling was added to the last-layer feature maps, then feed the feature to the randomly initialized linear layer. The AUC (area under the ROC curve) is used to evaluate the multi-label classification performance (ChestX-ray14, CheXpert and NIH Shenzhen CXR), while the accuracy is used to assess the multi-class classification performance (RSNA Pneumonia). In fine-tuning experiments, the AdamW optimizer was used with a cosine learning rate schedule, linear warm up of 20 epochs while the overall epoch is 150, and 0.0005 for the maximum learning rate value. The batch sizes are 32 and 128 for image sizes of 448 and 224, respectively. Training was conducted with the single Nvidia RTX3090 24G GPU for performing each experiment.

The pre-trained PEAC models are adapted to each target task through fine-tuning the whole parameters. For these tasks, a randomly initialized linear layer is appended to the output of the Classification (CLS) token in PEAC ViT-B models. Due to the inherent structural divergence from the VIT-B model, the PEAC Swin-B models do not feature a CLS token. Instead, an average pooling layer is introduced to the final-layer feature maps, which are subsequently inputted into the randomly initialized linear layer. The model's performance is evaluated using AUC (area under the ROC curve) for multi-label classification tasks (ChestX-ray14, CheXpert, NIH Shenzhen CXR), while accuracy metrics are employed for multi-class classification performance (RSNA Pneumonia). Fine-tuning experiments follow an optimization protocol using the AdamW optimizer, integrating a cosine learning rate schedule, a linear warmup spanning 20 epochs out of a total of 150, and a maximum learning rate value of 0.0005. Batch sizes are tailored to image size, with sizes of 32 and 128 used for images of 448 and 224 respectively. Each experiment was performed on a single Nvidia RTX3090 24G GPU.

4.7.1. Ablation Studies: PEAC Versions and their Performance

Our PEAC model involves four losses:
Patch order classification loss defined in the main paper as

$${ℒ}_{{θ}_{s}}^{oc} = - \frac{1}{B} {\sum }_{b = 1}^{B} {\sum }_{l = 1}^{n} {\sum }_{c = 1}^{n} y log {𝒫}^{o} \qquad ( 1 )$$

Patch appearance restoration loss defined in the main paper as

$${ℒ}_{{θ}_{s}}^{ar} = \frac{1}{B} {\sum }_{i = 1}^{B} {\sum }_{j = 1}^{n} {‖ {p}_{j} - {p}_{j}^{a} ‖}_{2}^{2} \qquad ( 2 )$$

Global patch embedding consistency loss defined in the main paper as [symbol] _{θ}_{ₛ}_{,θ}_{ₜ}^{G}= [symbol] _{θ}_{ₛ}_{,θ}_{ₜ}^{global}+ [symbol] _{θ}_{ₛ}_{,θ}_{ₜ}^{global}· [symbol] _{θ}_{ₛ}_{,θ}_{ₜ}^{global} and [symbol] _{θ}_{ₛ}_{,θ}_{ₜ}^{global} are computed from an exchanged inputs into the Student and Teacher models.

$${ℒ}_{{θ}_{s} , {θ}_{t}}^{global} {=}^{△} {‖ \overline{{y}_{s}} - \overline{{y}_{t}} ‖}_{2}^{2} = 2 - 2 \cdot \frac{{y}_{s} - {y}_{t}}{{‖ {y}_{s} ‖}_{2} \cdot {‖ {y}_{t} ‖}_{2}} \qquad ( 3 )$$

Local patch embedding consistency loss defined in the main paper as [symbol] _{θ}_{ₛ}_{,θ}_{ₜ}^{L}= [symbol] _{θ}_{ₛ}_{,θ}_{ₜ}^{local}+ [symbol] _{θ}_{ₛ}_{,θ}_{ₜ}^{local}· [symbol] _{θ}_{ₛ}_{,θ}_{ₜ}^{local} and [symbol] _{θ}_{ₛ}_{,θ}_{ₜ}^{local} are computed from an exchanged inputs into the Student and Teacher models.

$${ℒ}_{{θ}_{s} , {θ}_{t}}^{local} {=}^{△} \frac{1}{B} {\sum }_{b = 1}^{B} 𝕀 \cdot {\sum }_{i = 1}^{z} {‖ \overline{{p}_{{m}_{i}}} - \overline{{p}_{{m}_{i}}} ‖}_{2}^{2} \qquad ( 4 )$$

TABLE 4
The four loss functions were added one by one to show the effectiveness of the method described herein in terms of performance.
All models in the ablation studies are pretrained on ChestX-ray14 with Swin-B backbone at two different image resolutions and
also fine-tuned at two different image resolutions as denoted by PT→FT in the table. The official implementation PEAC achieves
the best performance on three target tasks with pretraining and finetuning resolutions set at 448 \acute{ } 448.

| | Shuffled | | Transformations | | POPAR Losses | | PEAC Losses | | Target Tasks | | |
|---|---|---|---|---|---|---|---|---|---|---|---|
| PEAC Version | Patches | PT→FT | OD | AD | [symbol] _{θ}_{ₛ}^{oc} | [symbol] _{θ}_{ₛ}^{ar} | [symbol] _{θ}_{ₛ}_{, θ}ₜ^{G} | [symbol] _{θ}_{ₛ}_{, θ}ₜ^{L} | ChestX-ray14 | ShenZhen | RSNA Pneumonia |
| PEAC₍ₒ₎⁻² | 49 | 224²→224² | ✓ | x | ✓ | x | x | x | 78.58 ± 0.17 | 92.65 ± 0.65 | 71.46 ± 0.41 |
| PEAC₍ₐ₎⁻² | | | x | ✓ | x | ✓ | x | x | 79.35 ± 0.18 | 93.85 ± 0.09 | 72.38 ± 0.15 |
| PEAC_{(o, a)}⁻² | | | ✓ | ✓ | ✓ | ✓ | x | x | 79.57 ± 0.22 | 95.10 ± 0.20 | 72.59 ± 0.13 |
| PEAC_{(g)}⁻² | 49 | 224²→224² | x | x | x | x | ✓ | x | 80.85 ± 0.14 | 96.59 ± 0.11 | 73.42 ± 0.41 |
| PEAC_{(o, g)}⁻² | | | ✓ | x | ✓ | x | ✓ | x | 81.13 ± 0.18 | 96.70 ± 0.11 | 73.75 ± 0.04 |
| PEAC_{(o, g, l)}⁻² | | | ✓ | x | ✓ | x | ✓ | ✓ | 81.09 ± 0.35 | 97.00 ± 0.28 | 74.42 ± 0.34 |
| PEAC_{(o, a, g)}⁻² | | | ✓ | ✓ | ✓ | ✓ | ✓ | x | 81.25 ± 0.16 | 96.91 ± 0.07 | 73.35 ± 0.19 |
| PEAC⁻² | | | ✓ | ✓ | ✓ | ✓ | ✓ | ✓ | 81.38 ± 0.03 | 97.14 ± 0.10 | 74.19 ± 0.15 |
| PEAC_{(o, a, g)}⁻¹ | 196 | 448²→224² | ✓ | ✓ | ✓ | ✓ | ✓ | x | 81.51 ± 0.22 | 97.07 ± 0.37 | 73.63 ± 0.42 |
| PEAC⁻¹ | | | ✓ | ✓ | ✓ | ✓ | ✓ | ✓ | 81.90 ± 0.15 | 97.17 ± 0.42 | 73.70 ± 0.48 |
| PEAC_{(o, a, g)} | 196 | 448²→448² | ✓ | ✓ | ✓ | ✓ | ✓ | x | 82.67 ± 0.11 | 97.15 ± 0.40 | 74.18 ± 0.52 |
| PEAC | | | ✓ | ✓ | ✓ | ✓ | ✓ | ✓ | 82.78 ± 0.21 | 97.39 ± 0.19 | 74.39 ± 0.66 |

Some ingredients were removed from the official implementation PEAC and the results (Table 4) show the effectiveness of all loss functions. The POPAR versions involve OD (patch order distortion) and AD (patch appearance distortion) which are studied in and the losses include patch order classification loss [symbol] _{θ}_{ₛ}^{oc}, patch appearance restoration loss [symbol] _{θ}_{ₛ}^{ar}. The downgraded version PEAC₍ₐ₎⁻² only include OD, in this circumstance one can only compute [symbol] _{θ}_{ₛ}^{oc} and neglect the [symbol] _{θ}_{ₛ}^{ar}. Correspondingly, only AD is added for the downgraded version PEAC-3, in this case one can only compute [symbol] _{θ}_{ₛ}^{ar} and neglect the [symbol] _{θ}_{ₛ}^{oc}. The PEAC versions involve the four loss functions mentioned above. Under the same settings (the same shuffled patches and the same pretraining and fine-tuning resolutions), these loss functions were added one by one, and the downstream tasks performance improve successively shown in Table 4.

Our pretraining and fine-tuning setting include two resolutions 448×448 and 224×224. The downgraded versions PEAC-2 contain 49 pretraining shuffled patches and are pretrained and fine-tuned on 224 size of images while the downgraded versions PEAC-1 include 196 shuffled patches and are pretrained on 448 and fine-tuned on 224 size of images. And the performances on the official implementation PEAC (pretrained and fine-tuned on 448 images) are the best. To accelerate the training process, only two versions PEAC and PEAC_{(o,a,g)} can be pretrained on 448 images.

### 4.7.II Ablations: Local and Global Consistency

### PEAC Local Consistency Improves Performance

The local consistency loss was added and based on several methods VICRegL, SimMIM shown in Table 5. In the instance of VICRegL, ConvNext serves as the backbone, with the subsequent addition of local consistency loss precipitating notable enhancements in performance across all three target tasks. The SimMIM methodology employs Swin-B as its backbone, with the sequential addition of global and local consistency losses leading to marked improvements in performance. Moreover, the removal of local consistency loss from the PEAC method corresponds to a decline in performance across the target classification tasks. This evidence underscores the efficacy of the proposed grid-matched local consistency loss.

TABLE 5
The local consistency loss in PEAC consistently improves the performance across methods and target tasks.

| | | Transformations | | POPAR Losses | | PEAC Losses | | Target Tasks | | |
|---|---|---|---|---|---|---|---|---|---|---|
| Method | Backbone | OD | AD | [symbol] _{θ}_{ₛ}^{oc} | [symbol] _{θ}_{ₛ}^{ar} | [symbol] _{θ}_{ₛ}_{, θ}ₜ^{G} | [symbol] _{θ}_{ₛ}_{, θ}ₜ^{L} | ChestX-ray14 | ShenZhen | RSNA Pneumonia |
| VICRRegL | ConNeXt-B | x | x | x | x | x | x | 79.89 ± 0.34 | 94.29 ± 0.40 | 73.27 ± 0.15 |
| VICRegL₍ₗ₎ | | x | x | x | x | x | ✓ | 80.15 ± 0.11 | 95.21 ± 0.11 | 73.86 ± 0.43 |
| SimMIM | Swin-B | x | x | x | x | x | x | 79.09 ± 0.57 | 93.03 ± 0.48 | 71.99 ± 0.55 |
| SimMIM_{(g)} | | x | x | x | x | ✓ | x | 81.42 ± 0.04 | 97.11 ± 0.26 | 73.95 ± 0.18 |
| SimMIM_{(g, l)} | | x | x | x | x | ✓ | ✓ | 81.67 ± 0.04 | 97.86 ± 0.07 | 74.25 ± 0.24 |
| PEAC_{o, a, g} | Swin-B | ✓ | ✓ | ✓ | ✓ | ✓ | x | 82.67 ± 0.11 | 97.15 ± 0.40 | 74.18 ± 0.52 |
| PEAC | | ✓ | ✓ | ✓ | ✓ | ✓ | ✓ | 82.78 ± 0.21 | 97.39 ± 0.19 | 74.39 ± 0.66 |

### 4.7.III. PEAC Global Consistency Boosts Performance

Corresponding to Section 4.3 (3) the experiments in Table 6 demonstrate that using Teacher-Student model with global embedding consistency can boost one branch methods. Experiments were conducted based on SimMIM and the inventive method described herein which are all based on Swin-B backbone, pretrained on ChestX-ray14, pretrained and fine-tuned on 224 image resolution. When adding teacher branch for SimMIM to compute the global embedding consistency loss, the classification performances of SimMIM_{(g)} for the three target tasks are significantly improved. Importantly, the input images of the two branches are the two global views which are grid-wise cropped using the subject method and the student branch in SimMIM_{(g)} gets the masked patches as SimMIM while the teacher branch gets no augmentations for the input images. The teacher branch was also added to the one branch methods POPAR_{od}⁻² and POPAR⁻² for computing the global consistency loss. The downstream performances on the two branches Teacher-Student models PEAC_{(o,g)}⁻² and PEAC_{(o,a,g)}⁻² are much better than one branch methods POPAR_{od}⁻² and POPAR⁻².

### 4.7.IV. Visualization of Upstream Models

### Cross-Patient and Cross-View Correspondence

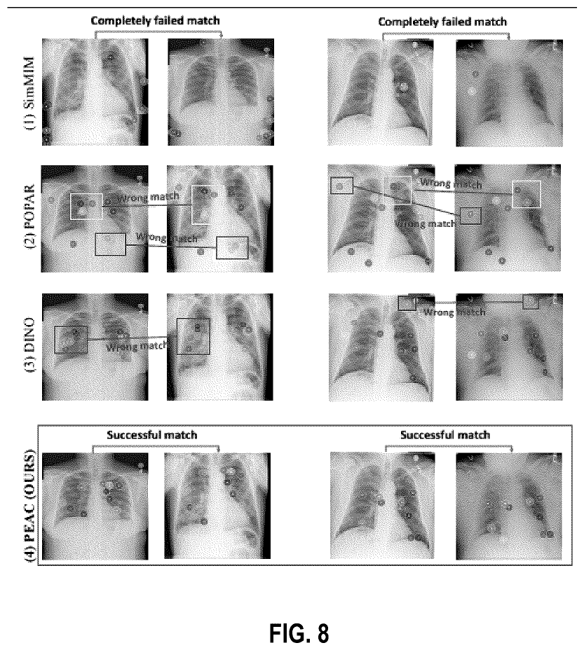

To investigate the promotion of the subject method for sensing local anatomy, small local patches were matched across two patients' and one patient's different views of X-ray. FIG. 8 shows the cross-patient correspondence of the PEAC and other methods. Each image was divided with a resolution of 224 into 196 image patches using ViT-B backbone and match the patch embedding of each image patch to the most similar patch embedding in another image. Finally, the top 10 most similar image patches were selected with K-means and drew the correspondence points. By comparing the correspondence results of the methods described herein with SimMIM, POPAR and DINO in FIG. 8, it was learned that the subject method PEAC can learn the local anatomy more precisely.

TABLE 6
The global loss in PEAC consistently boosts the performance across methods and target tasks.

| | Transformations | | POPAR Losses | | PEAC Losses | | Target Tasks | | |
|---|---|---|---|---|---|---|---|---|---|
| Method | OD | AD | [symbol] _{θ}_{ₛ}^{oc} | [symbol] _{θ}_{ₛ}^{ar} | [symbol] _{θ}_{ₛ}_{, θ}ₜ^{G} | [symbol] _{θ}_{ₛ}_{, θ}ₜ^{L} | ChestX-ray14 | ShenZhen | RSNA Pneumonia |
| SimMIM | x | x | x | x | x | x | 79.09 ± 0.57 | 93.03 ± 0.48 | 71.99 ± 0.55 |
| SimMIM_{(g)} | x | x | x | x | ✓ | x | 81.42 ± 0.04 | 97.11 ± 0.26 | 73.95 ± 0.18 |
| POPAR_{od}⁻² | ✓ | x | ✓ | x | x | x | 78.58 ± 0.17 | 92.65 ± 0.65 | 71.46 ± 0.41 |
| PEAC_{(o, g)}⁻² | ✓ | x | ✓ | x | ✓ | x | 81.13 ± 0.18 | 96.70 ± 0.11 | 73.75 ± 0.04 |
| POPAR⁻² | ✓ | ✓ | ✓ | ✓ | x | x | 79.57 ± 0.22 | 95.10 ± 0.20 | 72.59 ± 0.13 |
| PEAC_{(o, a, g)}⁻² | ✓ | ✓ | ✓ | ✓ | ✓ | x | 81.38 ± 0.03 | 96.91 ± 0.10 | 74.19 ± 0.15 |

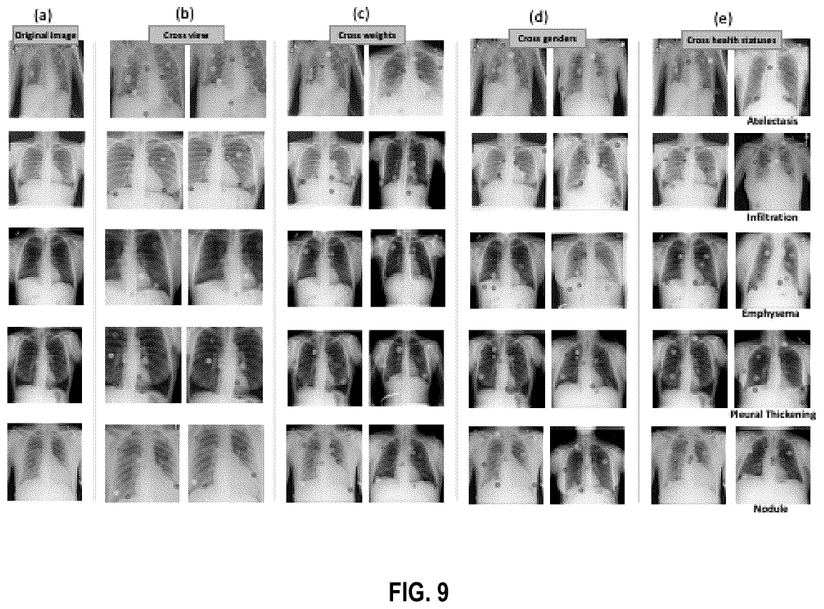

The PEAC method was also used to match anatomical structures from a patient with no finding (disease) to patients of different weights, different genders, and different health statuses as shown in FIG. 9. The results show that the PEAC can consistently and precisely capture similar anatomies across different views of the same patients and across patients of opposite genders, different weights, and various health statuses.

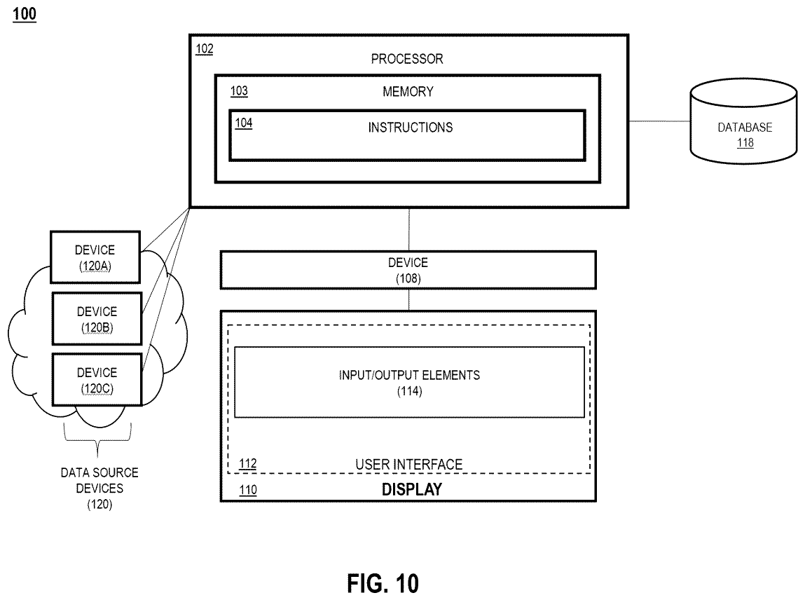

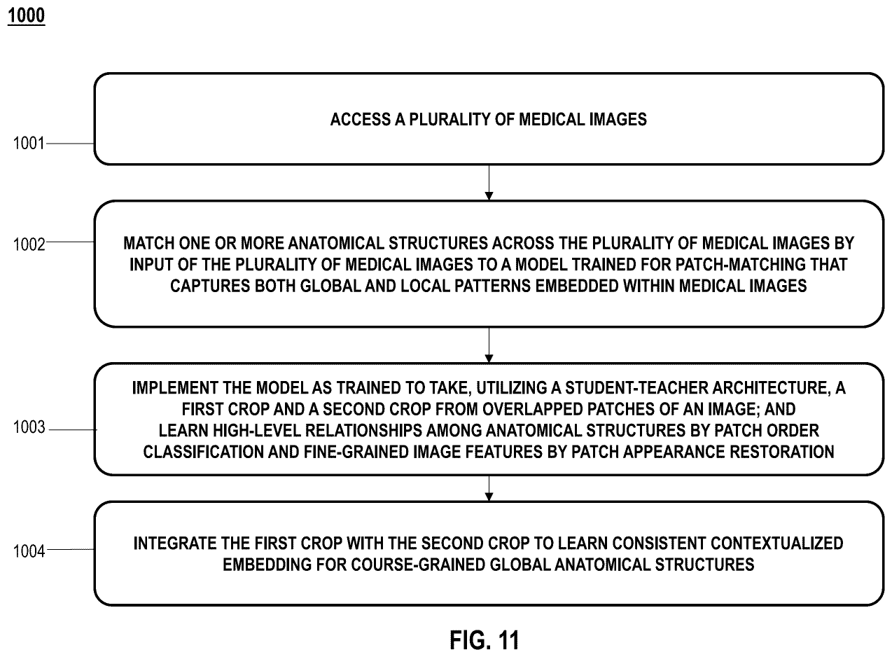

Referring to FIG. 10, embodiments of a computer-implemented system, designated system 100, can be configured for the PEAC model described herein. In general, as indicated, the system 100 includes at least one processor 102 or processing element that is configured for executing functions/operations described herein; e.g., the processor 102 can execute instructions 104 stored in a memory 103 including any form of machine-readable medium. In general, the processor 102, via instructions, accesses input data (e.g., images) via one or more data source devices 120 and is configured via the PEAC model (or associated instructions) for improving consistency in learning visual representations of anatomical structures in medical images via one or more functions, such as stable grid-based matching for ensuring global and local consistency in anatomy.

The instructions 104 may be implemented as code and/or machine-executable instructions executable by the processor 102 that may represent one or more of a procedure, a function, a subprogram, a program, a routine, a subroutine, a module, an object, a software package, a class, or any combination of instructions, data structures, or program statements, and the like. In other words, one or more of the features for processing described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable and the processor 102 performs the tasks defined by the code. In some embodiments, the processor 102 is a processing element of a cloud such that the instructions 104 may be implemented via a cloud-based web application.

In some examples, the processor 102 access input data from a device 108 (e.g., end-user device) in operable communication with a display 110. An end-user, via a user interface 112 rendered along the display 110, can provide input elements 114 to the processor 102 and receive output elements for executing functionality herein. In addition, examples of the system 100 can include a database 118 for storing datasets, images, and other input data as described herein.

The PEAC (patch embedding of anatomical consistency) model described herein relates to a novel self-supervised learning (SSL) framework or scheme for improving consistency in learning visual representations of anatomical structures in medical images and includes a new method, called stable grid-based matching, for ensuring global and local consistency in anatomy. Through extensive experiments, the effectiveness of the scheme was demonstrated (compared to existing state-of-the-art methods). By accurately identifying the features of each common region across patients of different genders and weights and across different views of the same patients, PEAC exhibited a heightened potential for enhanced Al in medical image analysis.

Example features include:
A straightforward yet effective SSL scheme that captures both global and local patterns embedded within medical images;
A precise and stable patch-matching method that achieves anatomical embedding consistency in health and disease;
Extensive illustrations that show the capability of PEAC in matching anatomical structures across different patients and across different views of the same patient and in segmenting anatomical structures by zero-shot;
Thorough experiments that demonstrate the transferability of PEAC to various target tasks, outperforming SoTA full-supervised and self-supervised methods in classification and segmentation.
PEAC models outperform fully-supervised pretrained models on ImageNet and ChestX-ray14 datasets in four target tasks across architectures.
Even downgraded PEAC-1 and PEAC-3 outperform SoTA self-supervised ImageNet in four target tasks.
PEAC model can effectively localize arbitrary anatomical structures across views of the same patient and across patients of different genders and weights and of health and disease.

While a number of embodiments of the invention have been described, it is apparent that the basic examples may be altered to provide other embodiments that utilize the methods of this disclosure. Therefore, it will be appreciated that the scope of this invention is to be defined by the appended claims rather than by the specific embodiments that have been represented by way of example.

What is claimed is:

1. A system for medical image analysis, comprising:
a processor configured to execute one or more operations; and
a memory in operable communication with the processor storing instructions the processor executes to execute the one or more operations, to:
access a plurality of medical images; and
match one or more anatomical structures across the plurality of medical images by input of the plurality of medical images to a model trained for patch-matching that captures both global and local patterns embedded within medical images.

2. The system of claim 1, wherein the model associated with a self-supervised learning (SSL) framework that defines a Student-Teacher model to extract features of two crops simultaneously.

3. The system of claim 2, wherein the SSL framework includes an image augmentation and restoration module that aims to restore image crops from the two augmentation ways shuffle patches and add noise.

4. The system of claim 2, wherein the SSL framework includes a global module that aims to enforce the model to learn coarse-grained global features of two crops.

5. The system of claim 2, wherein the SSL framework includes a local module that aims to enforce the model to learn fine-grained local features from overlapped patches.

6. The system of claim 2, wherein under the SSL framework the model learns coarse-grained, fine-grained and contextualized high-level anatomical structure features.

7. The system of claim 1, wherein prior to input to the model, the plurality of medical images is pre-processed in grid-wise cropping to get two crops x, x′∈R^{C×H×W}, C is the number of channels, (H, W) are the crops' spatial dimensions.

8. The system of claim 7, wherein the two crops are input to Student and Teacher encoders f_{θ}_{ₛ}, f_{θ}_{ₜ} to get the local features s, t respectively.

9. The system of claim 8, wherein average pooling operators ⊕: R^{D×H×W}→R^{D} are performed on the local features and the pooled representations are denoted as y_{s⊕} and y_{t⊕}∈R^{D}.

10. The system of claim 1, wherein the processor applying the model in view of the plurality of medical images matches the anatomical structures across different patients.

11. The system of claim 1, wherein the processor applying the model in view of the plurality of medical images matches the anatomical structures across different views of the same patient.

12. The system of claim 1, wherein the model calculates the consistency loss based on the absolute positions of overlapping image patches of the plurality of medical images.

13. The system of claim 1, wherein the model as trained:
takes, utilizing a student-teacher architecture, a first crop and a second crop from overlapped patches of an image; and
learns high-level relationships among anatomical structures by patch order classification and fine-grained image features by patch appearance restoration.

14. The system of claim 13, wherein the model integrates the first crop with the second crop to learn consistent contextualized embedding for coarse-grained global anatomical structures.

15. The system of claim 1, wherein analogous regions of the plurality of medical images are captured by the first and second crops so that global embedding consistency encourages extraction of features of similar local regions.

16. The system of claim 1, wherein the model learns fine-grained and precise anatomical structures from local patch embeddings of overlapped parts.

17. The system of claim 1, wherein the model defines a network that that considers both global and local features of medical images at the same time.

18. The system of claim 1, wherein the model localizes arbitrary anatomical structures across views of the same patient and across patients of different genders and weights and of health and disease.

19. A method, comprising:
accessing a plurality of medical images; and
matching, by a processor, one or more anatomical structures across the plurality of medical images by input of the plurality of medical images to a model trained for patch-matching that captures both global and local patterns embedded within medical images.

20. A non-transitory, computer-readable medium storing instructions encoded thereon, the instructions, when executed by one or more processors, cause the one or more processors to perform operations to:
access a plurality of medical images; and
match one or more anatomical structures across the plurality of medical images by input of the plurality of medical images to a model trained for patch-matching that captures both global and local patterns embedded within medical images.
